(19) United States
(12) Patent Application Publication
(10) Pub. No.: US 2012/0285029 A1
(43) Pub. Date: Nov. 15, 2012

(54) TOOL FOR DRAWING

(76) Inventor: Seok Soo JUNG, Gyeryong-si (KR)

(21) Appl. No.: 13/107,822

(22) Filed: May 13, 2011

(51) Int. Cl. B43L 7/00

(52) U.S. Cl. 33/483

(57) ABSTRACT

The present invention relates to a tool for drawing which is capable of providing convenient painting representation of drawing such as a sketch, a study, cartoon, an independent drawing, and the like. The tool for drawing includes: a linear body; and a back-sight means which is formed in at least one point of the body and is perpendicular to the body. The tool for drawing greatly helps a user to sight a representation object of drawing precisely since the tool for drawing can be used as a reference to sight the representation to keep the tool for drawing always perpendicular to a direction at which eyes of the user points. In addition, the tool for drawing of the present invention has another advantage in that it can sight length, angle an so on of the representation object even more precisely and has a wide use for home life, construction and so on.

### BACKGROUND OF THE INVENTION

1. Field of the Invention

The present invention relates to a tool for drawing, and more particularly, to a tool for drawing which is capable of providing convenient painting representation of drawing such as a sketch, a study, cartoon, an independent drawing, and the like.

2. Description of the Related Art

The term ‘drawing’, which is the synonym of French ‘dessin’, refers generally to a painting representation using lines with using no color, covering a sketch for a painting plan or an idea development, a study for search for a painting representation, training of representation technique, or clarification of detailed or entire composition of a finished work, a cartoon for an original work such as a mural or the like, a drawing in a narrow sense which is an independent finished work.

Material for drawing may typically include, but is not limited to, a pencil, a charcoal, a conte, or the like.

Drawing is essential for all formative representations in that it creates a form of a representation object using monochromatic lines by observing a shape, proportion, distance, brightness, volume, texture, movement and the like from the representation object. Accordingly, many persons including experts and students have exerted great efforts to represent a desired shape precisely by learning usage of drawing material used for correct line drawing.

In most cases, a representation object is sighted with a writing tool such as a pencil for precise observation. In such cases, the writing tool as a reference for sight is needed to be changed in gesture within the entire range of 360° with the writing tool kept perpendicular to a direction at which eyes of a user point.

However, as many persons often have trouble in keeping the writing tool perpendicular to the direction of eyes, there is a keen need for effective and practical measures against such trouble.

### SUMMARY OF THE INVENTION

In the light of such circumstances, it is an object of the present invention to provide a tool for drawing which is capable of substantially helping a painting representation of drawing and being utilized for use in home life, construction and so on.

To achieve the above object, according to an aspect of the invention, there is provided a tool for drawing including: a linear body; and a back-sight means which is formed in at least one point of the body and is perpendicular to the body.

The tool for drawing of the present invention greatly helps a user to sight a representation object of drawing precisely since the tool for drawing can be used as a reference to sight the representation to keep the tool for drawing always perpendicular to a direction at which eyes of the user points. In addition, the tool for drawing of the present invention has another advantage in that it can sight length, angle an so on of the representation object even more precisely and has a wide use for home life, construction and so on.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a perspective view of a tool for drawing according to a first embodiment of the invention;

FIGS. 2 to 6 are partial perspective views of modifications of the tool for drawing according to the first embodiment;

FIG. 7 is a perspective view of a tool for drawing according to a second embodiment of the invention;

FIGS. 8 to 12 are partial perspective views of modifications of the tool for drawing according to the second embodiment;

FIG. 13 is a perspective view of a tool for drawing according to a third embodiment of the invention;

FIGS. 14 to 17 are partial perspective views of modifications of the tool for drawing according to the third embodiment;

FIG. 18 is a perspective view of a tool for drawing according to a fourth embodiment of the invention;

FIGS. 19 and 20 are schematic views showing a method of using the tool for drawing according to the fourth embodiment;

FIG. 21 is a sectional view of the tool for drawing according to the fourth embodiment;

FIGS. 22 and 23 are an exploded perspective view and a sectional view showing a first modification of the tool for drawing according to the fourth embodiment, respectively; and

FIGS. 24 and 25 are a front view and an exploded perspective view showing a second modification of the tool for drawing according to the fourth embodiment, respectively.

### DETAILED DESCRIPTION OF THE PREFERRED EMBODIMENT

Hereinafter, preferred embodiments of the present invention will be described in detail with reference to the accompanying drawings. The present invention may be modified in detailed configuration and operation in various ways without departing from the spirit and scope of the invention. In the following detailed description of the present invention, contents common to the following embodiments will be described in detail by way of a first embodiment, and other embodiments will be described with a stress placed on differences between these embodiments. Throughout the drawings, the same or similar elements are denoted by the same reference numerals for the purpose of avoiding repeated explanation.

### First Embodiment

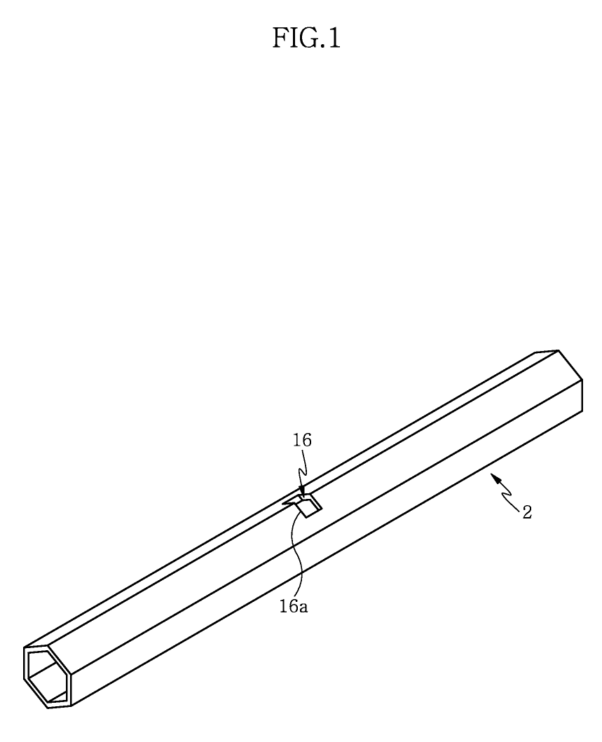

FIG. 1 is a perspective view of a tool for drawing according to a first embodiment of the invention.

The tool for drawing according to the first embodiment includes an elongated body 2 and a back-sight means 16 which is formed in at least one point of the body 2 and is perpendicular to the longitudinal direction of the body.

The body 2 is used to sight a representation object single-handed or with a pencil or the like inserted in one side of the body 2. In this embodiment, the body 2 is a bar or a pipe having a hexagonal or polygonal section perpendicular to the longitudinal direction. For reference, material of the body 2 may include, but is not limited to, metal, synthetic resin, wood or the like which is hard to be bent or broken. In addition, length, inter/outer width and so on of the body 2 may be properly adjusted.

The back-sight means 16 is used to arrange the body 2 perpendicular to a direction at which eyes of a user point. In this embodiment, the back-sight means 16 is a groove 16a or a line having a tetragonal or similar shape when viewed from the direction perpendicular to the body 2. Accordingly, when the user places the body 2 in the front of his/her eyes and adjusts the inner surface and bottom of both sides of the groove 16a to be in parallel to the eyes, the body 2 is placed to be perpendicular to the direction at which the eyes of the user point. For reference, the depth, width, length and so on of the groove 16a may be properly adjusted.

As a result, the user who uses the tool for drawing according to this embodiment can use the back-sight means 16 to sight the representation object even more precisely while rotating the body 2 freely within the entire range of 360° with the body 2 held perpendicular to the direction at which the eyes point.

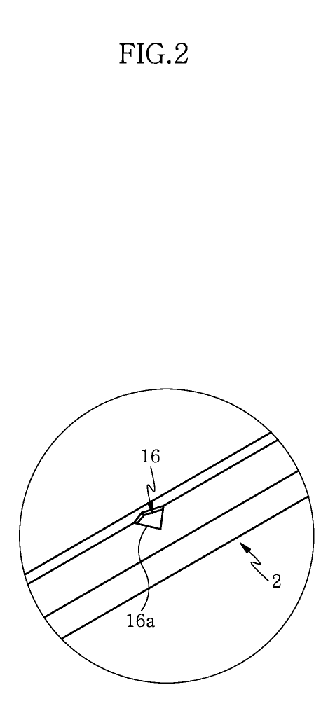

FIG. 2 is a partial perspective view of a first modification of the tool for drawing according to the first embodiment. In this embodiment, the body 2 is a bar or a pipe having a hexagonal or polygonal section perpendicular to the longitudinal direction and the back-sight means 16 is a groove 16a having a triangle or similar shape tapered into the inside of the body 2 when viewed from the direction perpendicular to the body 2. The body 2 and the back-sight means 16 have substantially the same function as those described earlier.

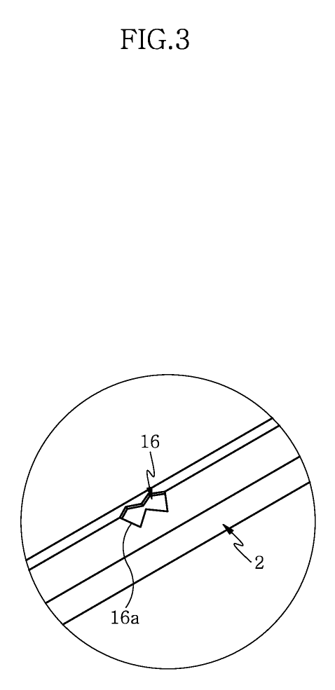

FIG. 3 is a partial perspective view of a second modification of the tool for drawing according to the first embodiment. In this embodiment, the body 2 is a bar or a pipe having a hexagonal or polygonal section perpendicular to the longitudinal direction and the back-sight means 16 is a groove 16a having a “W-like” (i.e., a double triangle-like) or similar shape tapered into the inside of the body 2 when viewed from the direction perpendicular to the body 2. The body 2 and the back-sight means 16 have substantially the same function as those described earlier.

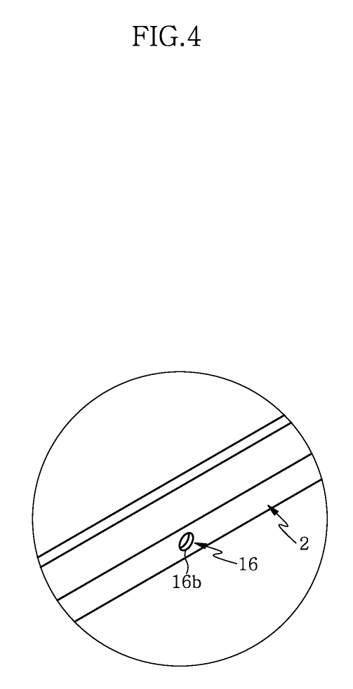

FIG. 4 is a partial perspective view of a third modification of the tool for drawing according to the first embodiment. In this embodiment, the body 2 is a bar or a pipe having a hexagonal or polygonal section perpendicular to the longitudinal direction and the back-sight means 16 is at least one hole 16b penetrating through the body 2. The body 2 and the back-sight means 16 have substantially the same function as those described earlier.

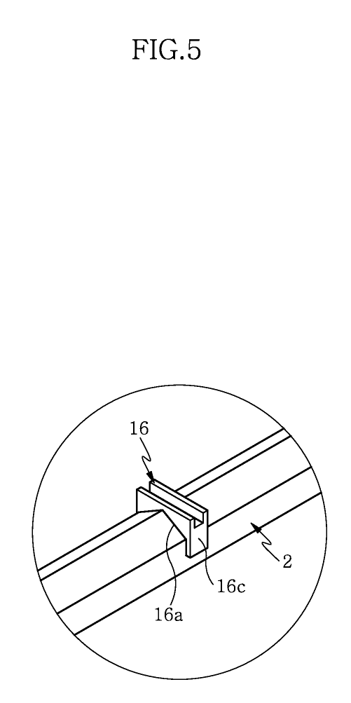

FIG. 5 is a partial perspective view of a fourth modification of the tool for drawing according to the first embodiment. In this embodiment, the body 2 is a bar or a pipe having a hexagonal or polygonal section perpendicular to the longitudinal direction and the back-sight means 16 includes a tetragonal groove 16a and a back-sight piece 16c inserted in the groove 16a when viewed from the direction perpendicular to the body 2. Here, the top of the back-sight piece 16c exposed to the outside of the groove 16a provides a plane perpendicular to the longitudinal direction of the body 2. The body 2 and the back-sight means 16 have substantially the same function as those described earlier. In addition, if necessary, the groove 16a may be omitted and, instead, a projection-like back-sight piece 16c may be attached to a portion of the outer surface of the body 2, and, preferably, a separate groove or line perpendicular to the longitudinal direction of the body 2 may be formed on the top of the back-sight piece 16c.

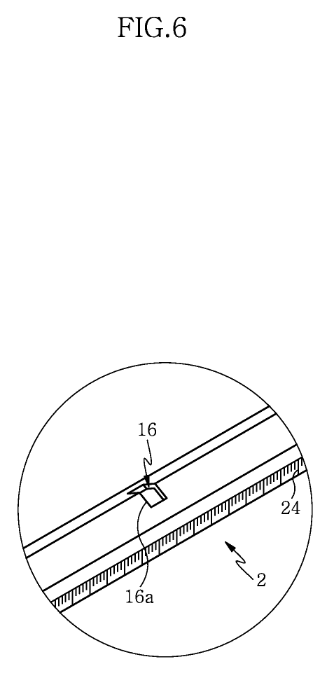

FIG. 6 is a partial perspective view of a fifth modification of the tool for drawing according to the first embodiment. In this embodiment, the body 2 is a bar or a pipe having a hexagonal or polygonal section perpendicular to the longitudinal direction. Here, a first gradation 24 for indication of length is imprinted along one side of the body 2. The back-sight means 16 is a tetragonal groove 16a or a line when viewed from the direction perpendicular to the body 2. Accordingly, the user can sight the length of the representation object even more precisely with the first gradation 24. Otherwise, the body 2 and the back-sight means 16 have substantially the same function as those described earlier.

The first embodiment and the modifications thereof described above are merely examples, and detailed features, quantity, position and so on of the body 2 and the back-sight means 16 may be modified in various ways.

### Second Embodiment

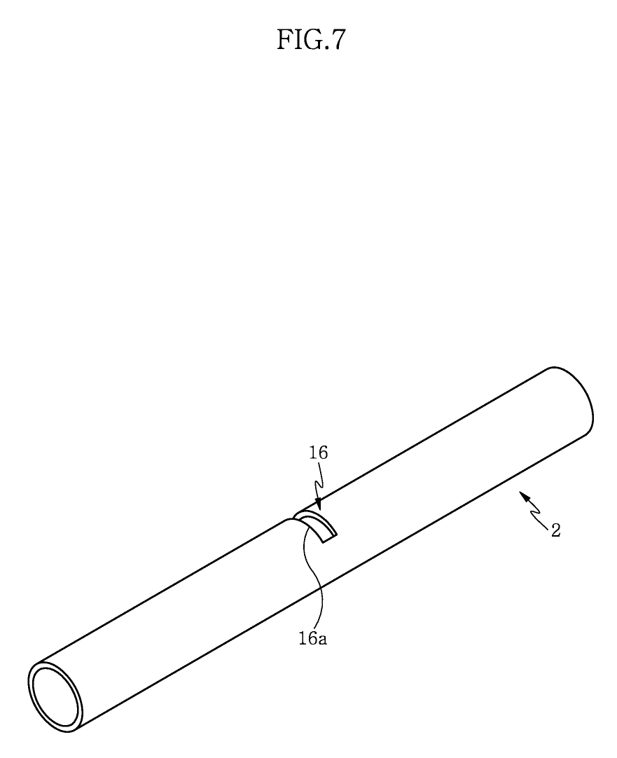

FIG. 7 is a perspective view of a tool for drawing according to a second embodiment of the invention.

The tool for drawing according to the second embodiment includes a body 2 which is formed of a bar or a pipe having a circular or elliptical section perpendicular to the longitudinal direction and a back-sight means 16 which is formed in at least one point of the body 2 and is perpendicular to the longitudinal direction of the body 2. The back-sight means 16 includes a groove 16a or a line having a tetragonal or similar shape when viewed from the direction perpendicular to the body 2. The body 2 and the back-sight means 16 have substantially the same function as those described earlier.

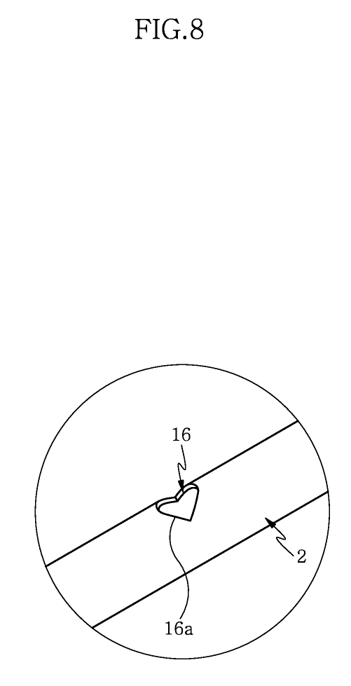

FIG. 8 is a partial perspective view of a first modification of the tool for drawing according to the second embodiment. In this embodiment, the body 2 is a bar or a pipe having a circular or elliptical section perpendicular to the longitudinal direction and the back-sight means 16 is a groove 16a having a triangle or similar shape tapered into the inside of the body 2 when viewed from the direction perpendicular to the body 2. The body 2 and the back-sight means 16 have substantially the same function as those described earlier.

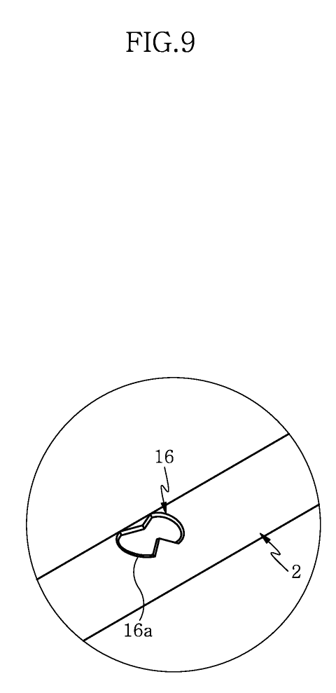

FIG. 9 is a partial perspective view of a second modification of the tool for drawing according to the second embodiment. In this embodiment, the body 2 is a bar or a pipe having a circular or elliptical section perpendicular to the longitudinal direction and the back-sight means 16 is a groove 16a having a “W-like” (i.e., a double triangle-like) or similar shape tapered into the inside of the body 2 when viewed from the direction perpendicular to the body 2. The body 2 and the back-sight means 16 have substantially the same function as those described earlier.

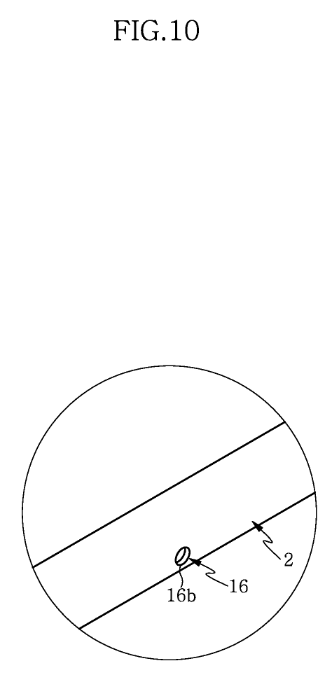

FIG. 10 is a partial perspective view of a third modification of the tool for drawing according to the second embodiment. In this embodiment, the body 2 is a bar or a pipe having a circular or elliptical section perpendicular to the longitudinal direction and the back-sight means 16 is at least one hole 16b penetrating through the body 2. The body 2 and the back-sight means 16 have substantially the same function as those described earlier.

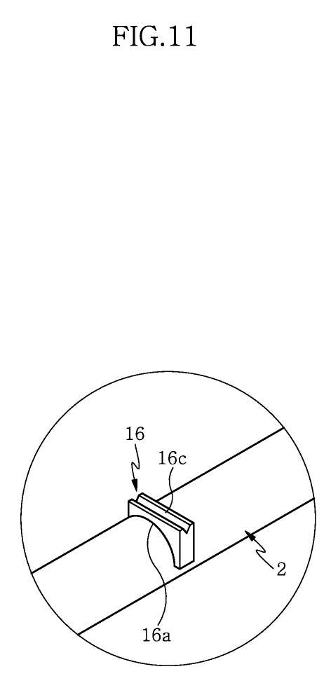

FIG. 11 is a partial perspective view of a fourth modification of the tool for drawing according to the second embodiment. In this embodiment, the body 2 is a bar or a pipe having a circular or elliptical section perpendicular to the longitudinal direction and the back-sight means 16 includes a tetragonal groove 16a and a back-sight piece 16c inserted in the groove 16a when viewed from the direction perpendicular to the body 2. The body 2 and the back-sight means 16 have substantially the same function as those described earlier. Here, preferably, a separate groove or line perpendicular to the longitudinal direction of the body 2 may be formed on the top of the back-sight piece 16c.

In addition, if necessary, the groove 16a may be omitted and, instead, a projection-like back-sight piece 16c may be attached to a portion of the outer surface of the body 2, and, preferably, a separate groove perpendicular to the longitudinal direction of the body 2 may be formed on the top of the back-sight piece 16c.

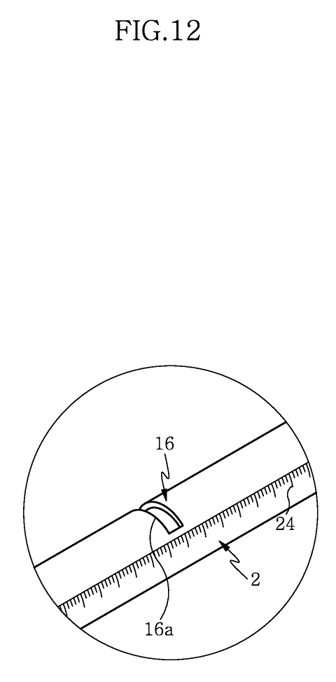

FIG. 12 is a partial perspective view of a fifth modification of the tool for drawing according to the second embodiment. In this embodiment, the body 2 is a bar or a pipe having a circular or elliptical section perpendicular to the longitudinal direction. Here, a first gradation 24 for indication of length is imprinted along one side of the body 2. The back-sight means 16 is a tetragonal groove 16a or a line when viewed from the direction perpendicular to the body 2. The body 2 and the back-sight means 16 have substantially the same function as those described earlier.

The second embodiment and the modifications thereof described above are merely examples, and detailed features, quantity, position and so on of the body 2 and the back-sight means 16 may be modified in various ways.

### Third Embodiment

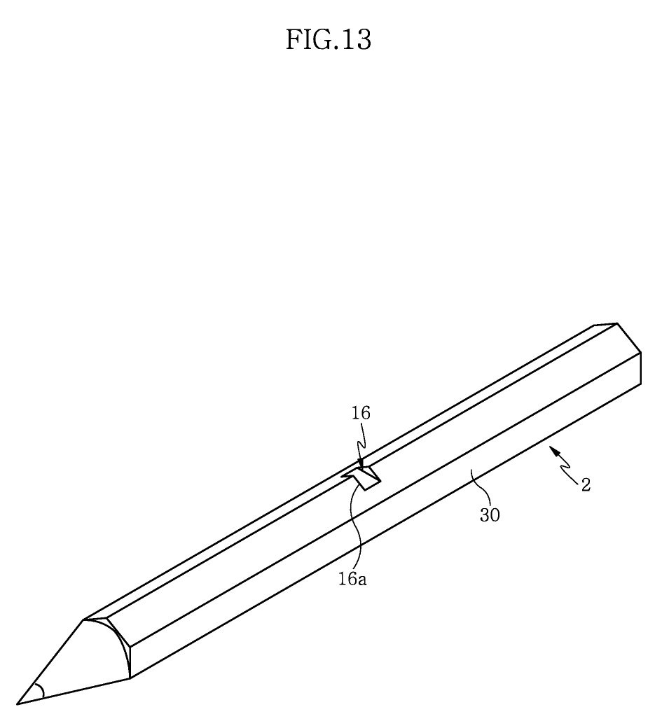

FIG. 13 is a perspective view of a tool for drawing according to a third embodiment of the invention.

The tool for drawing according to the second embodiment includes a body 2 which is formed of a writing tool 30 such as a pencil and a back-sight means 16 which is formed in at least one point of the body 2 and is perpendicular to the longitudinal direction of the body 2. The back-sight means 16 includes a groove 16a or a line having a tetragonal or similar shape when viewed from the direction perpendicular to the body 2. The body 2 and the back-sight means 16 have substantially the same function as those described earlier.

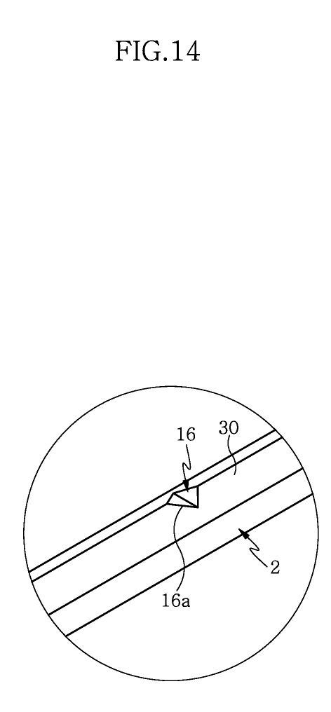

FIG. 14 is a partial perspective view of a first modification of the tool for drawing according to the third embodiment. In this embodiment, the body 2 is a writing tool 30 such as a pencil and the back-sight means 16 is a groove 16a having a triangle or similar shape tapered into the inside of the body 2 when viewed from the direction perpendicular to the body 2. The body 2 and the back-sight means 16 have substantially the same function as those described earlier.

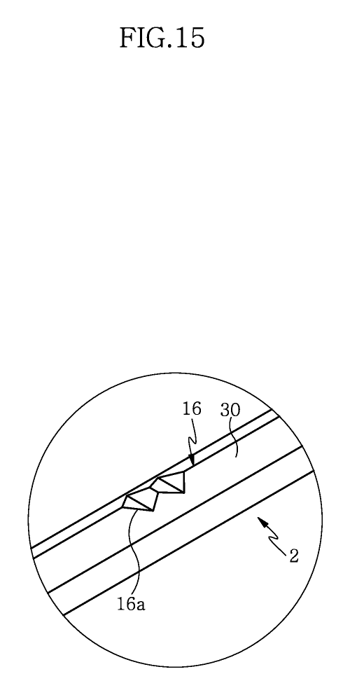

FIG. 15 is a partial perspective view of a second modification of the tool for drawing according to the third embodiment. In this embodiment, the body 2 is a writing tool 30 such as a pencil and the back-sight means 16 is a groove 16a having a “W-like” (i.e., a double triangle-like) or similar shape tapered into the inside of the body 2 when viewed from the direction perpendicular to the body 2. The body 2 and the back-sight means 16 have substantially the same function as those described earlier.

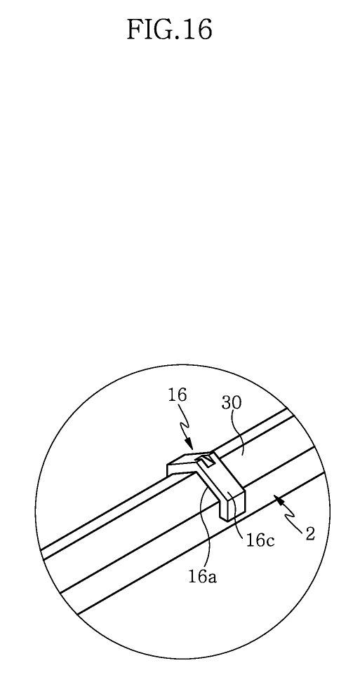

FIG. 16 is a partial perspective view of a third modification of the tool for drawing according to the third embodiment. In this embodiment, the body 2 is a writing tool 30 such as a pencil and the back-sight means 16 includes a tetragonal groove 16a and a back-sight piece 16c inserted in the groove 16a when viewed from the direction perpendicular to the body 2. The body 2 and the back-sight means 16 have substantially the same function as those described earlier. Here, if necessary, the groove 16a may be omitted and, instead, a projection-like back-sight piece 16c may be attached to a portion of the outer surface of the body 2, and, preferably, a separate groove or line perpendicular to the longitudinal direction of the body 2 may be formed on the top of the back-sight piece 16c.

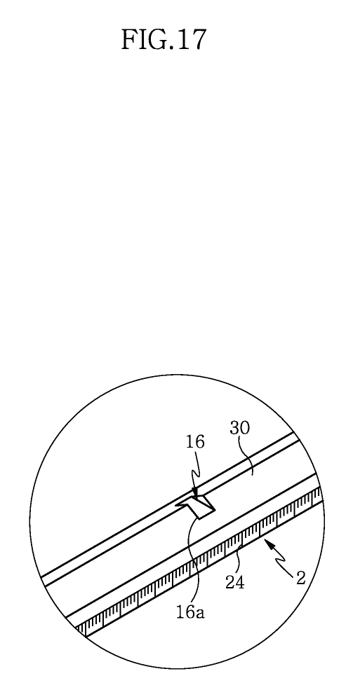

FIG. 17 is a partial perspective view of a fourth modification of the tool for drawing according to the third embodiment. In this embodiment, the body 2 is a writing tool 30 such as a pencil. Here, a first gradation 24 for indication of length is imprinted along one side of the body 2. The back-sight means 16 is a tetragonal groove 16a or a line when viewed from the direction perpendicular to the body 2. The body 2 and the back-sight means 16 have substantially the same function as those described earlier.

In this embodiment, the hole 16b penetrating through the body 2, which corresponds to the back-sight means 16, is omitted in consideration that the body 2 is the pencil. However, if necessary, the back-sight means 16 may be the hole 16b. The third embodiment and the modifications thereof described above are merely examples, and detailed features, quantity, position and so on of the body 2 and the back-sight means 16 may be modified in various ways.

### Fourth Embodiment

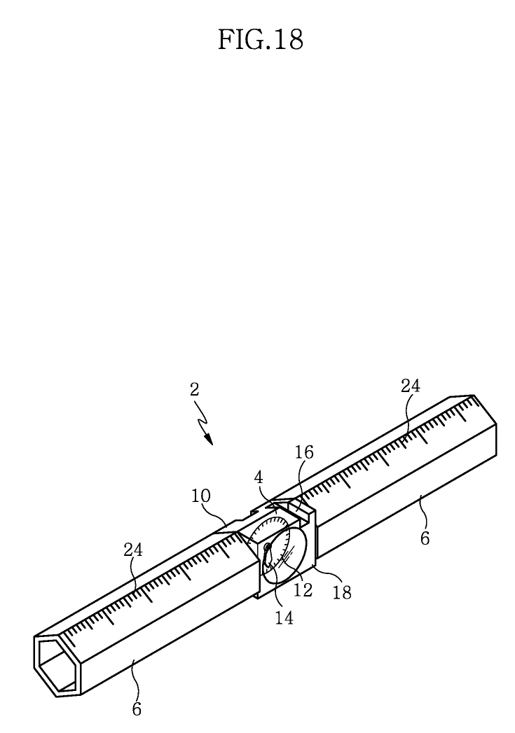

FIG. 18 is a perspective view of a tool for drawing according to a fourth embodiment of the invention.

In this embodiment, the body 2 includes a measurement device 10 having a self-weight goniometer 4, and a linear extension means 6 extending from at least one side of the measurement device 10. At least one of the measurement device 10 and the extension means 6 includes a groove or a line as the back-sight means 16 perpendicular to the longitudinal direction of the body 2.

The self-weight goniometer 4 includes a second gradation 12 for angle indication, which is imprinted along one side of the measurement device 10, and a self-weight pointer 14 rotatably fixed to the axial center of the second gradation 12. Preferably, a transparent cover 18 for protecting the second gradation 12 and the self-weight pointer 14 is covered on the front side of the measurement device 10.

The extension means 6 is a bar or a pipe having a hexagonal, polygonal, circular or elliptical section perpendicular to the longitudinal direction and may be imprinted with the first gradation 24 for length indication along the longitudinal direction of the extension means 6.

Feature, quantity, position and so on of the back-sight means 16 may be modified in various ways as described in the first to third embodiments and the modifications thereof.

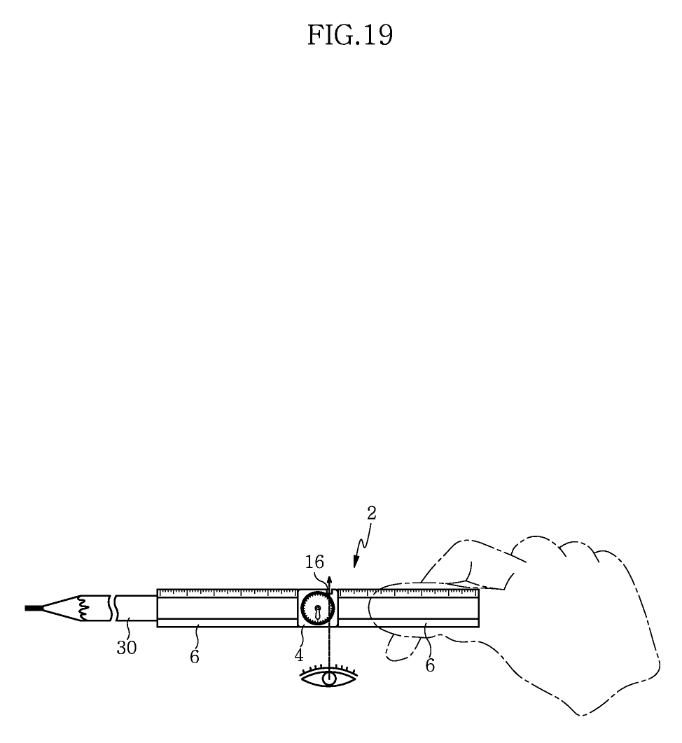

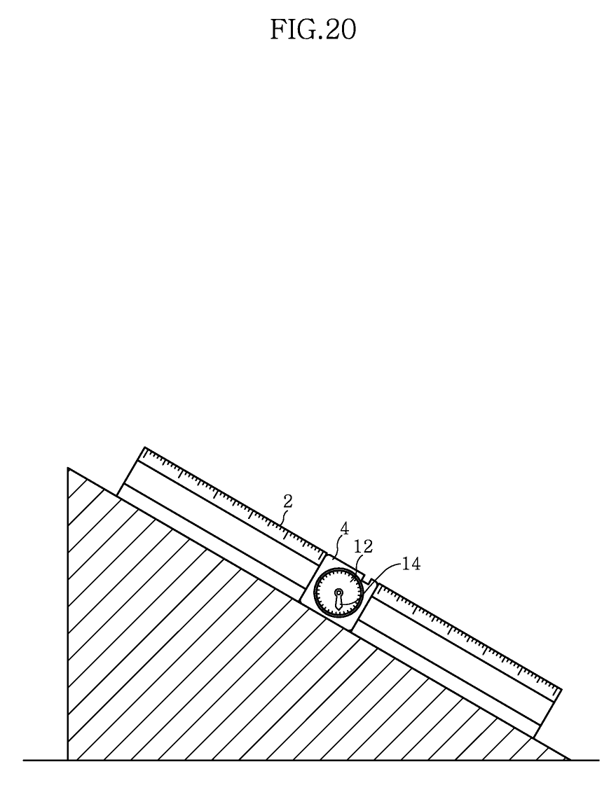

FIGS. 19 and 20 are schematic views showing a method of using the tool for drawing according to the fourth embodiment.

As shown in FIG. 19, if the extension means 6 has a pipe shape, when the user places the body 2 in the front of his/her eyes while using the writing tool 30 such as a pencil inserted in the body 2 and adjusts the back-sight means 16 to be in parallel to the eyes, the body 2 is placed to be perpendicular to the direction at which the eyes of the user point. Thus, when the body 2 is inclined to a representation object, an angle of the representation object can be even more precisely estimated through the self-weight goniometer 4.

In addition, the self-weight goniometer 4 may be used to measure an angle of an object inclined as shown in FIG. 20.

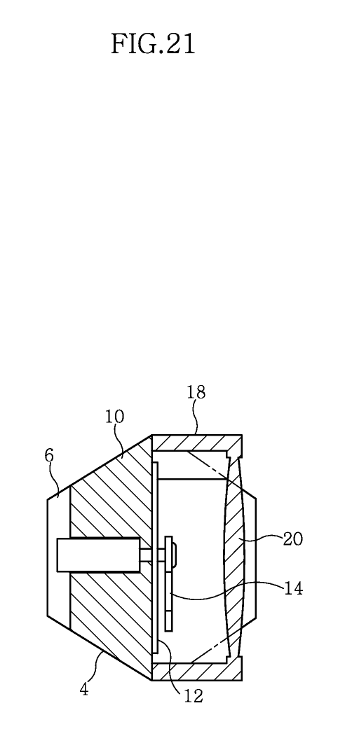

FIG. 21 is a sectional view of the tool for drawing according to the fourth embodiment, where a cutting plane line perpendicular to the longitudinal direction of the body 2 passes through the center of the self-weight goniometer 4. As shown in FIG. 21, a convex lens 20 may be formed on the transparent cover 18.

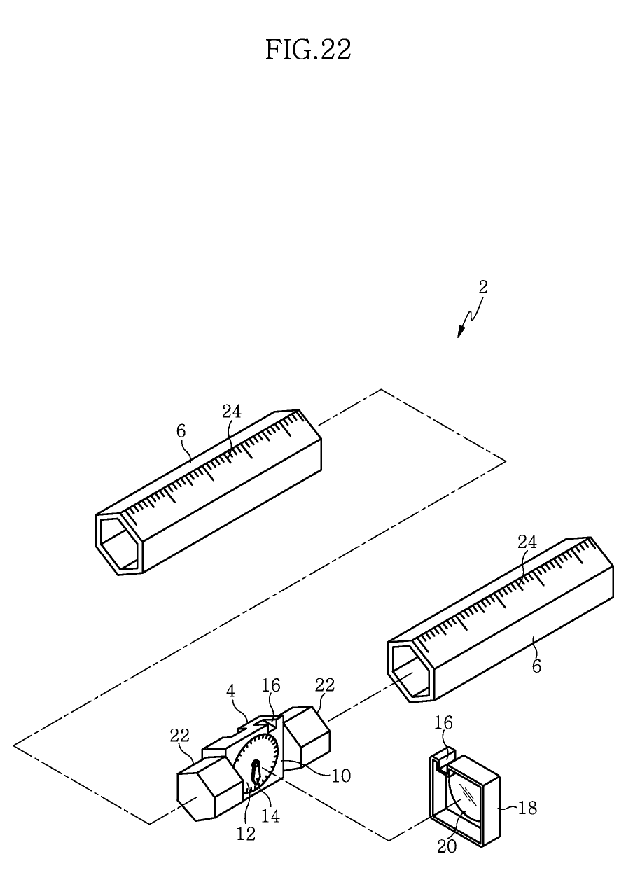

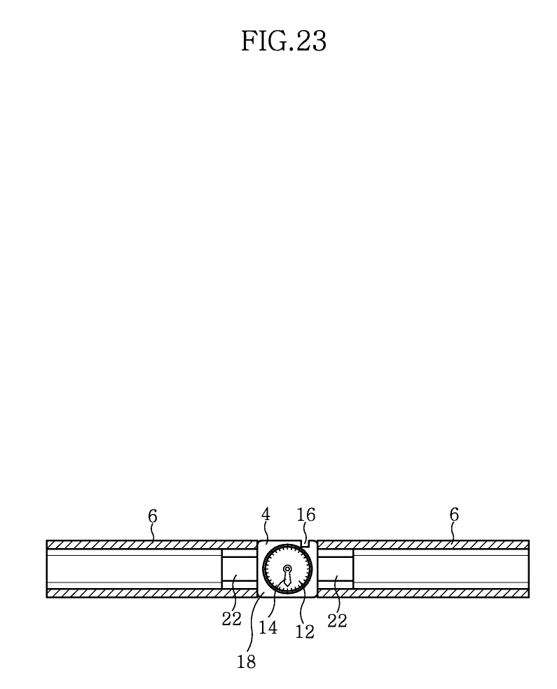

FIG. 22 is an exploded perspective view showing a first modification of the tool for drawing according to the fourth embodiment and FIG. 23 is a sectional view where a cutting plane line in parallel to the body 2 passes through the center of the extension means 6. As shown in FIG. 22, a fitting part 22 in which the extension means 6 is fitted is formed in at least one of the left and right sides of the measurement device 10.

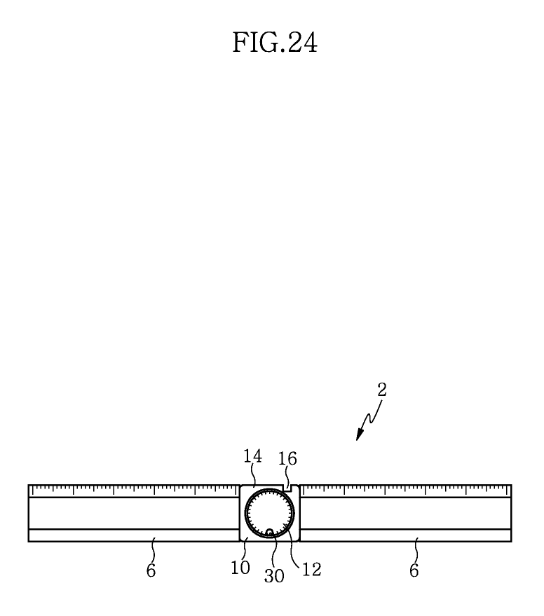

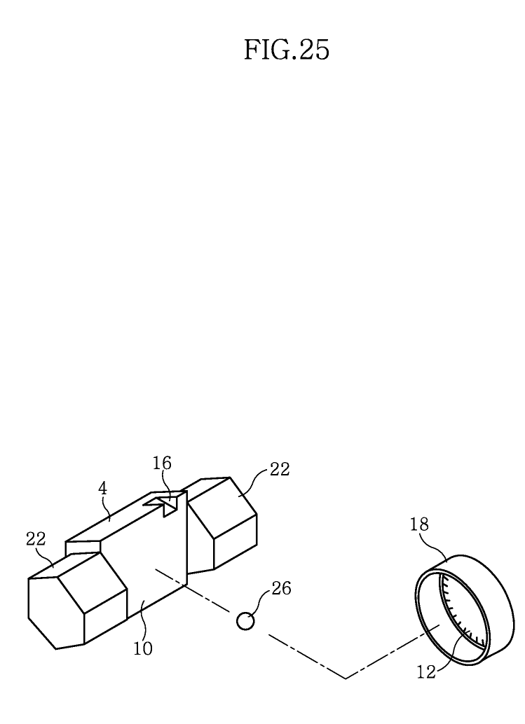

FIGS. 24 and 25 are a front view and an exploded perspective view showing a second modification of the tool for drawing according to the fourth embodiment, respectively.

The self-weight goniometer 4 includes a cylindrical transparent cover 18 covering one side of the measurement device 10, a second gradation 12 for angle indication, which is imprinted along one side of the measurement device 10 or the inner side of the transparent cover 18, and a self-weight ball 26 mounted on the transparent cover 18. The self-weight goniometer 4 has the same function as those described earlier.

In addition, although not shown in the figures, instead of the self-weight pointer or the self-weight ball, bubbles or the like may be inserted in the transparent cover 18 after filling with predetermined liquid, which provides the same function as described earlier.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A tool for drawing comprising:
a linear body; and
a back-sight means which is formed in at least one point of the body and is perpendicular to the body.

2. The tool for drawing according to claim 1, wherein the body is a bar or a pipe having a polygonal, circular or elliptical section perpendicular to the longitudinal direction of the body, and the back-sight means is at least one groove or line formed in one side of the body, or at least one hole passing through the body, or a projecting back-sight piece attached to a portion of the outer surface of the body.

3. The tool for drawing according to claim 1, wherein the body is a writing tool including a pencil, and the back-sight means is at least one groove or line formed in one side of the body, or at least one hole passing through the body, or a projecting back-sight piece attached to a portion of the outer surface of the body.

4. The tool for drawing according to claim 1, further comprising a first gradation for length measurement, which is formed along the longitudinal direction of the body.

5. The tool for drawing according to claim 1, wherein the body includes:
a measurement device including a self-weight goniometer; and
a linear extension means extending from at least one side of the measurement device.

6. The tool for drawing according to claim 5, wherein the extension means is a bar or a pipe having a polygonal, circular or elliptical section perpendicular to the longitudinal direction of the extension means, and the back-sight means at least one groove or line formed in one side of the measurement device and the extension means, or at least one hole passing through at least one of the measurement device and the extension means.

7. The tool for drawing according to claim 5, wherein the self-weight goniometer includes:
a second gradation for angle measurement, which is formed along one side of the measurement device; and
a self-weight pointer which is rotatably fixed to the axial center of the second gradation.

8. The tool for drawing according to claim 5, wherein the self-weight goniometer includes:
a second gradation for angle measurement, which is formed along one side of the measurement device;
a cylindrical transparent cover which covers the second gradation; and
a self-weight ball which is mounted within the transparent cover.

9. The tool for drawing according to claim 5, wherein the self-weight goniometer includes:
a second gradation for angle measurement, which is formed along one side of the measurement device;
a cylindrical transparent cover which covers the second gradation and is filled with liquid; and
bubbles which are contained within the transparent cover.
